(19) United States
(12) Patent Application Publication
(10) Pub. No.: US 2004/0027827 A1
(43) Pub. Date: Feb. 12, 2004

(54) Illuminated fans & light fixtures

(76) Inventors: Robert M. Currie, Longbeach, MS (US); Jonas J. Robertson, Harvey, LA (US)

Correspondence Address: Merek, Blackmon & Voorhees, LLC, 673 S. Washington St., Alexandria, VA, 22202, US

(21) Appl. No.: 10/376,484

(22) Filed: Mar. 3, 2003

Related U.S. Application Data
(60) Provisional application No. 60/360,948, filed on Mar. 2, 2002.
(60) Provisional application No. 60/361,852, filed on Mar. 6, 2002.

(51) Int. Cl. F21V 33/00

(52) U.S. Cl. 362/253

(57) ABSTRACT

A method of illuminating ceiling and standing fans and light fixtures using black light wherein the fans and components thereof and the light fixtures are either made of black light reactive plastic or are covered with black light reactive plastic. The black light is either attached to the fan or in the alternative is used to illustrate the fan from a short distance away. The ceiling and base cover plate, the blades and the lamp fixture or housing are all made of black light reactive plastic or poly acrylic. The handing or standing mounting extension rod, and the metal fan motor housing, are covered with, or coated with, the black light reactive plastic in order to maintain their strength and electrical conductivity. The lamp fixture on the bottom of a hanging fan made in this manner has one or more black light bulbs installed in a way that illuminates the fan. The black light reacts with the black light UV poly acrylic reactive plastic causing the fan blades and all parts of the fan made of black light reactive plastic to glow. Different colored black light reactive plastic or LISA plastic can be used to make or coat different parts of the fan, or the entire fan, and said parts will glow in the color selected. The use of reflective coating such as a white florescent coating on the back can be used to enhance the visual effect of lighting on the plastic pieces.

### REFERENCE TO RELATED PATENT APPLICATION

This application claims the benefit of U.S. Provisional Patent Application Serial No. 60/360,948 filed on Mar. 2, 2002 and U.S. Provisional Patent Application Serial No. 60/361,852 filed on Mar. 6, 2002.

### BACKGROUND OF THE INVENTION

1. Field of the Invention

The present invention relates generally to illumination devices. More specifically, the invention relates to illuminated fans, particularly cooling fans, fan blades and components, and illuminated light fixtures of all types including ceiling, floor and hanging light fixtures wherein the means of illumination include black light, light emitting diodes (LEDs), and LISA Plastic.

2. Background of the Invention

Cooling fans mounted in the ceiling and floor mounted fans are extremely popular and can be found either in the bedroom, kitchen, living room, dining room or family room of most new homes built today. Many of these fans, especially the ceiling fans, also have a conventional light (usually a florescent of some type) attached thereto. Many of these conventional lights come in decorative shapes and are generally designed with elegance in mind. These conventional lights are also designed without the fans and are known in the art as light fixtures. These fans and light fixtures serve a three-fold purpose. Firstly, they provide cooling in the summertime and can re-circulate the heat during the wintertime. Secondly, the conventional lighting (either attached to a fan or serving as light fixtures) can illuminate the room with soft lighting. Thirdly, most ceiling fans and light fixtures of today are designed in such a way as to add beauty and aesthetic qualities to a room. There is a fourth “dimension” not covered in fan blades or light fixtures today. This fourth dimension or purpose includes people who are not listed in the ordinary or average category. They love things that are different, unique, against the grain, peculiar but interesting while maintaining a classy or sophisticated look. The present invention fulfills the stated purposes.

At the present time, there are no light fixtures, ceiling fans, floor fans, or any other type of fan wherein the fan and its components are illuminated by the use of a combination of black light and black light reactive plastic, LEDs, or LISA Plastic. The source of the black light can either be attached on the fan or located nearby. The fans and fan components can be either made from or covered by black light reactive plastic. The present invention illuminates the fan blades, the mounting pipes or rods, the motor housings, ceiling cover plates and base stands in different colors without affecting the strength and safety of the metal hanging or standing mount. The present invention creates very unique, esthetic, decorative fan appliances and light fixtures. There are no known fans or light fixtures that describe the instant invention as claimed.

### SUMMARY OF THE INVENTION

Both the black light fans and black light light fixtures have a common or central design. Basically, the fans or fixtures are covered with the special black light reactive plastic such that when black light (or ultraviolet light) is shined on them a colorful light appears. In the alternative, the fans or fixtures could be made of the black light reactive plastic in one of the manufacturing processes described later.

Accordingly, it is a principal object of the invention to illuminate fan blades, rods or pipes supporting the fans, fan housings, cover plates, stands and light fixtures.

It is another object of the invention to illuminate fans and light fixtures and the various components via black light.

It is a further object of the invention to illuminate fans and light fixtures and the various components by covering the fans, light fixtures and components with black light reactive plastic.

Still another object of the invention is to make the fans, light fixtures and components out of the black light reactive plastic.

It is an object of the invention to attach the black light to the fan or light fixture or in the alternative, to shine the black light on the fan or light fixture from a distance.

Yet another object of the invention is to make the black light reactive plastic in different colors such that a variety of colors can be incorporated with the black light.

These and other objects of the present invention will become readily apparent upon further review of the following specification and drawings.

### BRIEF DESCRIPTION OF THE DRAWINGS

FIG. 1 illustrates a front view of a combination ceiling fan and light fixture.

FIG. 2 illustrates a front view of a combination ceiling fan and light fixture with a stylized cover.

FIG. 3 illustrates a retro-fit with reflective coating members dimensioned and configured to fit over piping used to secure fans and light fixtures.

FIG. 4 illustrates a front view of a floor fan.

FIG. 5 illustrates a fan blade made out of LISA plastic.

FIG. 6 shows a ceiling fan according to a further embodiment of the invention having fans blades that include a reflective layer.

FIG. 7 shows a cross section of the piping of the fan according to the further embodiment taken along line 7-7.

FIG. 8 shows a cross section of the fan blade of the fan according to the further embodiment taken along line 8-8.

Similar reference characters denote corresponding features consistently throughout the attached drawings.

### DETAILED DESCRIPTION OF THE PREFERRED EMBODIMENTS

The present invention describes a way to make safe, decorative illuminated fan blades, fan motor housings, ceiling cover plates, fan extension mounts and light fixtures made out of black light reactive plastic or acrylic or in the alternative using the black light reactive plastic to cover the fans and its components and the light fixtures.

In a first embodiment, the ceiling and base cover plate, the blades and the lamp fixture or housing are all made of black light reactive plastic or poly acrylic. The handing or standing mounting extension rod, and the metal fan motor housing, are covered with, or coated with, the black light reactive plastic in order to maintain their strength and electrical conductivity. The lamp fixture on the bottom of a hanging fan made in this manner has one or more black light bulbs installed in a way that illuminates the fan. The black light reacts with the black light UV poly acrylic reactive plastic causing the fan blades and all parts of the fan made of black light reactive plastic to glow. Different colored black light reactive plastic can be used to make or coat different parts of the fan, or the entire fan, and said parts will glow in the color selected.

Different parts of the fan could be illuminated with different directional black lights providing a means to illuminate different parts of said fan at different times and to vary the black light illumination intensity on different fan components. A means may be provided to vary illumination intensity in the form of a rheostat or solid-state dimmer. A means may also be provided to automatically power on or off various black lights at the same or at different times, changing the color of the fan components. The illuminated fan blades or fan housings may also function as a night-light. A bottom section, a top section, or the entire fan may be illuminated for this purpose.

A form of any of these black light reactive fan components may be made into a retrofit conversion package to convert an ordinary fan into one with illuminated blades, cover or base plates, hanging or standing extension rods, or the complete fan. The electrical power to the black light lamps that provide the illumination for all of the above embodiments may be remote controlled.

The second embodiment of this instant invention utilizes the UV poly acrylic black light reactive plastic to cast or mold parts of, or complete light and lamp fixtures, including the lampshades, such as Tiffany™ style shades with their many colors and shapes, and lamp stands. Any component of a light or lamp fixture that would not be adversely affected by heat from the light bulb could be manufactured from UV reactive plastic. All types of ceiling, floor standing, hanging, desk, table, bed, cabinet, bench, recessed, outdoor, automobile, truck, aircraft, watercraft, or any other type of light fixture or mounting is intended to be included in this second embodiment.

An alternative method of lighting the fan blades and other components includes the use of LISA Plastic. “LISA” is an abbreviation for the German word “lichtsammeln” which means “light collecting”. Ambient light is absorbed by the LISA plastic and emitted as long wavelength fluorescent light. A material made out of LISA plastic has been shown to brilliantly illuminate or reflect light.

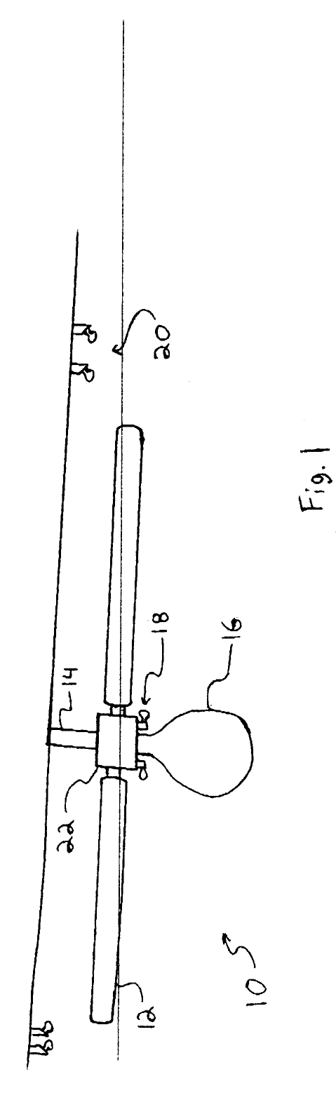

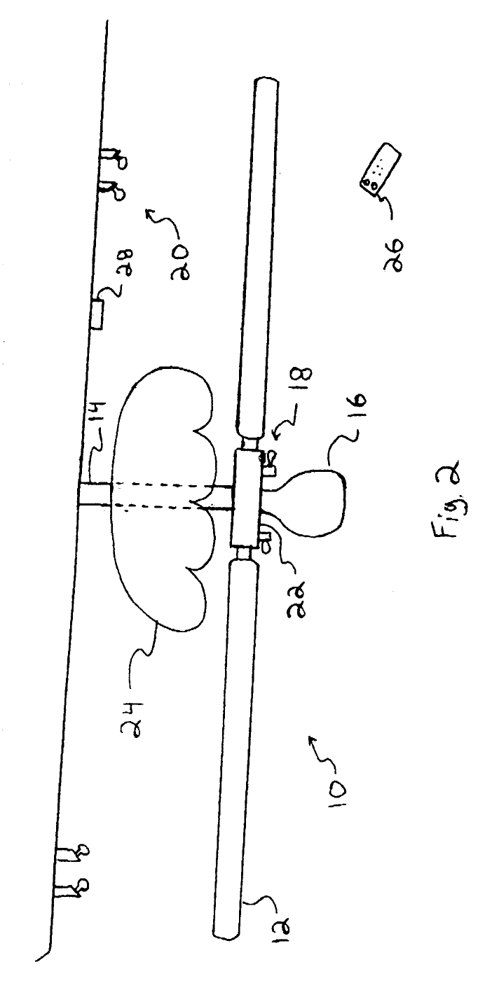

Turning now to FIG. 1 of the drawings, a ceiling fan 10 has piping 14 attached to a fan base 22 from which is secured fan blades 12, light fixture 16 and first black lights 18. Fan blades 12, piping 14 and fan base 22 are all coated with ultraviolet or UV poly acrylic reactive plastic. First black light 18 or exterior black lights 20 are useful in illuminating ceiling fan 10. Likewise, FIG. 2 shows a ceiling fan 10 with a decorative cover 24 coated with ultraviolet poly acrylic reactive plastic. Control box 28 is controlled by remote controller 26 and can turn black lights 18 and 20 on and off and also controls the intensity of the black lights.

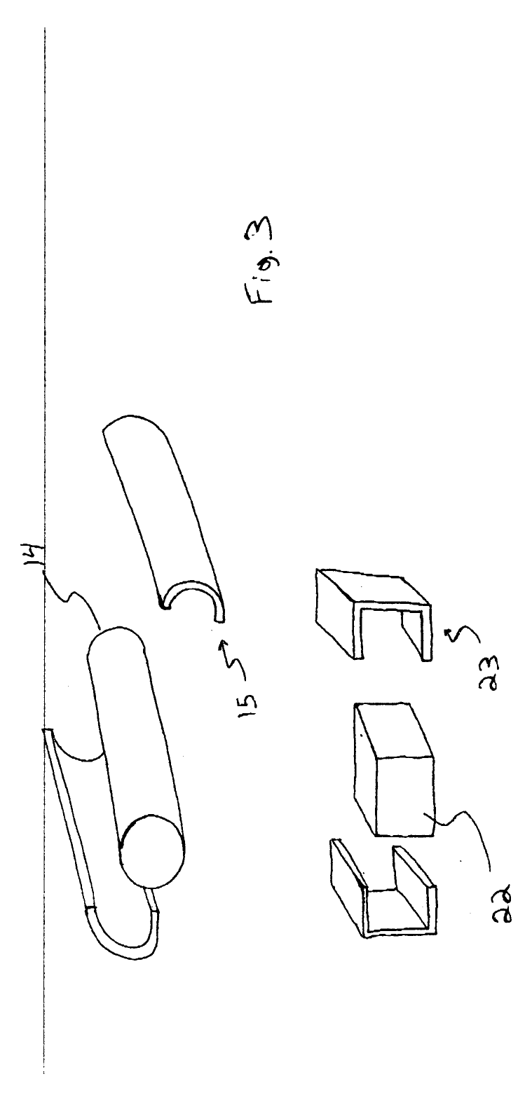

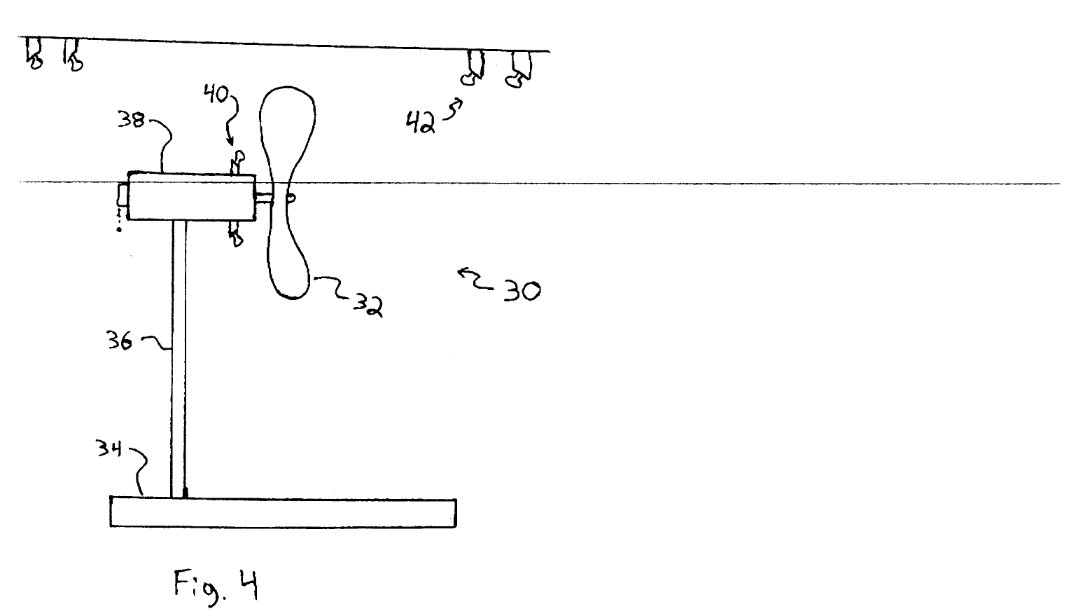

FIG. 4 shows a floor or standing fan 30 having a base 34, vertical column 36, motor base 38, fan blades 32 and fan mounted black lights 40. The base 34, vertical column 36, motor base 38 and fan blades 32 are all coated with ultraviolet or UV poly acrylic reactive plastic such that they show a bright reflective glow when black light from either the fan mounted black lights 40 or the exterior black lights 42 are shined on them. For present fans that do not have the special coating, a retro-fit is possible. FIG. 3 shows such a retro-fit wherein the piping 14 or fan motor 22 are covered with material 15, 23 which in turn are coated with ultraviolet or UV poly acrylic reactive plastic.

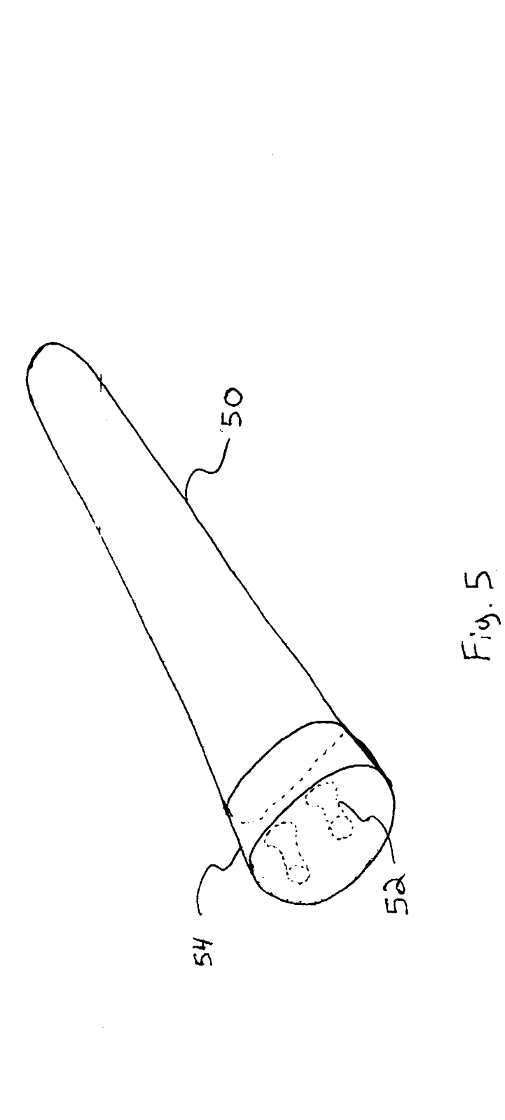

FIG. 5 shows a fan blade 50 made out of LISA plastic material. The blade base 54 has disposed therein a plurality of light emitting diodes or LEDs which are used to illuminate the fan blade 50. The fan blade 50 will be illuminated based on the color of the LEDs 52. For instance, a red LED will cause the fan blade 50 to illuminate in red.

FIG. 6 shows a further embodiment of a fan 110 according to the present invention. The ceiling fan 110 has piping 114 attached to a fan base 122 from which is secured fan blades 112, 212, light fixture 116 and optional first black lights 18. Fan blades 112, piping 114 and fan base 122 may be coated with ultraviolet or UV poly acrylic reactive plastic or modified as shown in FIG. 3 to provide a surface of UV reactive plastic. As shown in the first embodiment, black lights 118 can be used in illuminating ceiling fan 110. When illuminated from the lights 118 exterior to the fan blades, an opaque coating may be applied to a surface of the fan blade. In FIG. 6, an upper surface of the fan blade has a white florescent backing layer, element or sleeve 142 affixed thereto. The lower surface of the backing layer is preferably reflective to further enhance the black light effect on the fan blades and to cause the blades to appear to have more volume when the black light is shone on the blades.

The backing layer may of course be other than white, but it has been found that white provides the most flexibility in lighting effects on the blades. The backing layer can be applied as a self-adhesive tape, extruded on to the body of the blades at the time of manufacture or otherwise affixed or applied to the fan blades.

The white backing layer is especially useful when, as shown in fan blade 212 of FIG. 6 a light source is directed laterally into the fan blade where a portion of the light will reflect off of backing surface 142 before exiting the blade to provide a visual definition of the volume of the blade. If the backing surface 142 is white, then the light source 139 (or 118 or other light) can be used to influence the apparent color of the plastic fan blade 212. A black light (“UV light source”) can be used to cause the UV poly acrylic reactive plastic fan blades to “glow” when the ambient light is low such as in a darkened room. However, by using an LED light source 139 having multiple selectable light sources or one light capable of changing colors, the apparent color of the fan blades can be changed by changing the light source color. By shining, for instance, a red LED (or other red light) 139 onto the fan blade 212 with a white backing surface 142, the blade will take on a red glow even in day light. By shining a green LED 139 onto the fan blades, the fan blade 212 will appear to be green, thus providing distinctly separate day and night time functional lighting to provide a pleasing lighting character to the fan.

Fan blade 112 is constructed similar to fan blade 212, but provides an optional hollow profile as shown in FIG. 8. A white florescent or other backing surface 142 can be added to the upper surface of the fan blade 212 or to the upper surface of the inner pocket 144 of the fan blade. Additionally a surface 146 can be applied to the interior along all of then walls to provide a consistent look from any side. This is especially important when the fan is a vertical fan as shown in FIG. 4. A light or lights 138 provided at the end of the blade will react with the outer reflective surface of the backing 146 to cause the fan blade 212 to take on different light effects. Additionally, if a coating 146 is applied which is reflective from the outside but translucent or florescent from interior lighting, an interior light 136 can be used to cause the lighting effects on the fan blade. The backing 146 may be scored or otherwise applied with less than 100 percent coverage of the interior fan pocket walls to allow some light to pass from the interior out while effective blocking substantially all of the light from passing from outside the fan into the fan pocket, thus in effect being translucent to internal lights and reflective to light outside the pocket.

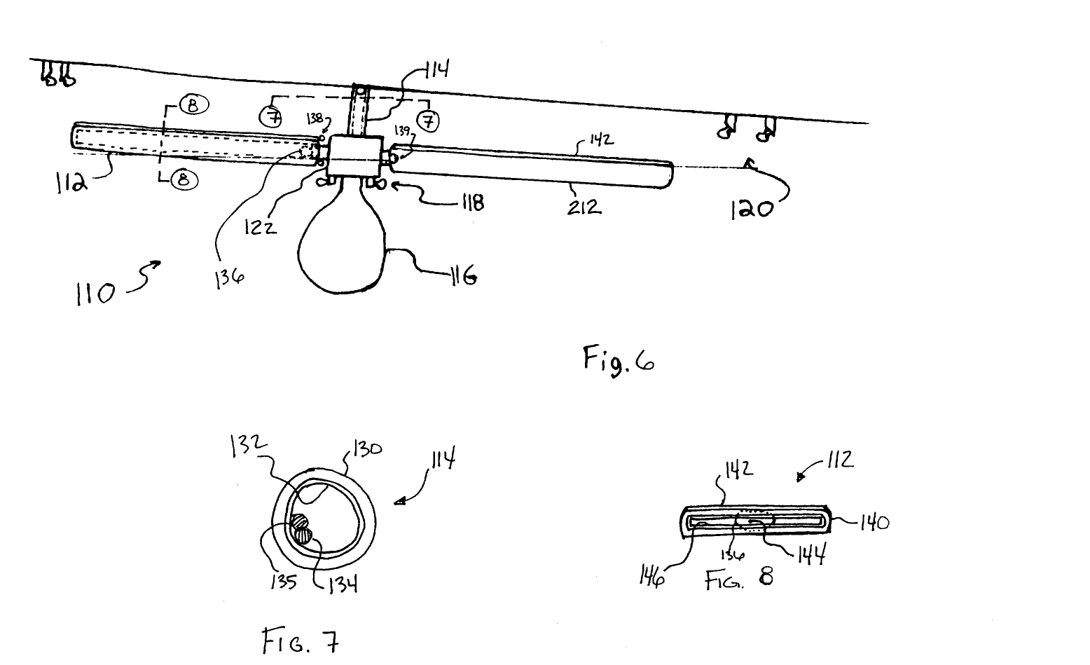

In a similar manner, the fan piping 114 can be hollow as shown in FIG. 6 and in FIG. 7. A white florescent opaque backing 132 or similar coating or element or sleeve can be applied along the interior wall of the hollow piping body 130. The backing 132 be scored or otherwise applied with less than 100 percent coverage of the interior fan piping body to allow some light to pass from the interior out while effective blocking substantially all of the light from passing from outside the fan piping into the fan body, thus in effect being translucent to internal lights and reflective to light outside the fan piping. This is especially useful to hide electrical wiring 134, 135 or similar electrical or control lines.

Likewise, FIG. 2 shows a ceiling fan 10 with a decorative cover 24 coated with ultraviolet poly acrylic reactive plastic. Control box 28 is controlled by remote controller 26 and can turn black lights 18 and 20 on and off and also controls the intensity of the black lights.

These embodiments may use a black light source as a component of the uses cited, or may be illuminated by a black light source remote from the fan or light fixture to be illuminated. It is to be understood that the present invention is not limited to the sole embodiments described above, but encompasses any and all embodiments within the scope of the following claims.

We claim:

1. A fan and lighting fixture comprising;
a plurality of fan blades,
a motor housing,
an extension rod, wherein said plurality of fan blades, said motor housing and said extension rod all are coated with UV poly acrylic reactive plastic.

2. Said fan according to claim 1 wherein a plurality of black lights are used to illuminate the plurality of fan blades, motor housing and extension rod.

3. Said fan according to claim 2 further comprising;
a light fixture,
a decorative cover wherein said decorative cover is coated with a UV poly acrylic reactive plastic

4. Said fan according to claim 3 further comprising a control box and remote controller for use in controlling the intensity of the plurality of black lights.

5. A fan and lighting fixture comprising;
a plurality of fan blades,
a motor housing,
an extension rod,
means to illuminate the fan blades, motor housing and extension rod.

6. The fan according to claim 5 further comprising a light and a plurality of black lights.

7. The fan according to claim 6 wherein said means to illuminate the fan blades, motor housing and extension rod comprise coating the fan blades, motor housing and extension rod with UV poly acrylic reactive plastic.

8. The fan according to claim 6 wherein said means to illuminate the motor housing and extension rod comprise placing a material with UV poly acrylic reactive plastic coating over the motor housing and extension rod.

9. The fan according to claim 8 wherein said means to illuminate the fan blades comprise coating the fan blades with UV poly acrylic reactive plastic.
